(19) United States
(12) Patent Application Publication
(10) Pub. No.: US 2007/0011165 A1
(43) Pub. Date: Jan. 11, 2007

(54) Retracting rights to digital works

(75) Inventor: Daniel W. Manchala, Torrance, CA (US)

Correspondence Address: Anthony L. Miele;Miele Law Group, 137 South Main Street, Natick, MA, 01760, US

(73) Assignee: Xerox Corporation.

(21) Appl. No.: 11/174,899

(22) Filed: Jul. 5, 2005

(51) Int. Cl. G06F 17/30

(52) U.S. Cl. 707/9

(57) ABSTRACT

In accordance with one embodiment, an apparatus includes a user interface, a media mechanism, and a retraction request mechanism. The media mechanism provides user access to digital work via the user interface in accordance with usage rights associated with the digital work. The retraction request mechanism requests a retraction of the usage rights.

One or more aspects of the present disclosure may relate to systems and methods for managing usage rights to digital works.

### BACKGROUND

Publishing and media distribution continue to spread and evolve, e.g., because of the Internet. In this climate, enforcing copyrights and ensuring that fair royalty payments are made to authors, artists, and other media become ever more difficult. Once in digital form, a copyrighted work, be it a word processing document, song, video, multimedia file, or some other form of data, may be duplicated readily and distributed at will.

Digital rights owners are more frequently tracking and controlling the distribution of media across electronic networks in order to ensure authorized use of media files, and to protect the copyright holders. In one digital rights scheme, Microsoft Windows® 2003 server and workstation, a user buys usage rights for a media file (for example, a document, image file, or movie), and an electronic descriptor of the user's rights (for example, view without printing, edit, print, print a limited number of copies, use for only a specified duration of time) is encoded in the media file itself. When the media file is read, viewed, or played by the user's computer system, the media file's electronic rights descriptor is checked by the user's viewing, printing, or editing software to ensure that the user does not exceed his or her rights in the use of the media file. This feature is described more fully in U.S. Pat. Nos. 5,629,980 and 5,715,403, both issued to Stefik et al.

As described in U.S. Pat. No. 5,634,012, a fee accounting system may require users to pay a fee each time they use an original work in their own creations. This same U.S. patent describes a system that requires users to pay on a metered basis or scheduled basis, with options for special discounts or mark-ups involving third parties (e.g., distributors).

### BRIEF SUMMARY

In accordance with one embodiment, apparatus are provided that comprise a user interface, a media mechanism, and a retraction request mechanism. The media mechanism provides user access to a digital work via the user interface in accordance with usage rights associated with the digital work. The retraction request mechanism requests a retraction of the usage rights to the digital work.

### BRIEF DESCRIPTION OF THE DRAWINGS

One or more embodiments are further described in the detailed description, which follows, by reference to the noted drawings, and wherein:

FIG. 1 is a schematic block diagram of a retraction system.

FIG. 2 is a schematic block diagram of a data structure associated with an API.

FIG. 3 is a flow diagram of a retracting process between a user and owner.

FIG. 4 is a schematic block diagram of a user interface on a user computer system.

FIG. 5 is a schematic block diagram of an owner interface on an owner computer system.

### DETAILED DESCRIPTION

In embodiments, “user” may be construed to be, e.g. a person or entity that uses or incorporates another's digital work in creating its own work or for its own purposes; such as an editor, author, or publisher. An “owner” may be a person or entity who possesses the ownership rights regarding the use, distribution or publication of a certain digital work, e.g., an author or a distributor. The owner from whom the user purchased usage rights may have transferred or sold those rights to another person or entity by the time the user seeks a retraction of those paid rights. If so, in certain embodiments, the user may need to interact with the new owner.

In embodiments herein, a “digital work” or “work” may, e.g., include digital information including, e.g., an audio, video, text, or multimedia composition. In embodiments, a digital work or work may further include data, a program, or an interpreter necessary to access the work. In embodiments, a digital work may be a collection of digital works.

In embodiments described herein “usage rights” or “rights” may be construed to be permissions granted to the user from the owner. For example, they may specify when and how a work may be used and/or whether a work may be further distributed. The usage rights may provide the user with the certain abilities regarding the content of the digital work, e.g., print, edit, copy, and/or use.

In embodiments, usage rights may be attached to, embedded within or otherwise associated with the digital work. The rights may have been previously paid by the user (or someone else), or another type of consideration may have been provided in return for the usage rights.

Rights may be encoded into or otherwise encapsulated into the digital work. For instance, usage rights may be a statement attached to the digital work, defined using usage rights grammar (e.g., as described in U.S. Pat. No. 5,715,403 to Stefik et al.), or encoded using a glyph format.

In embodiments herein, the usage rights information may not be perceived as part of the work. For example, it may not be perceptible to the human eye if the work is a visual work, and not be audible to the human ear if the work is an audible work.

The retraction of the usage rights to a digital work may involve the return of part or all of the rights, and in embodiments, the retraction may depend on whether any of the rights were used by the user. In embodiments, additional information otherwise associated with the rights may be attached to or otherwise associated with a digital work; such as a running tally on the number of uses of the work or fee payment information.

In embodiments, an application programming interface (API) may be construed to be an interface between one program on the one hand and another program, an operating system, hardware and/or other functionality on the other hand.

In embodiments herein, a “computer system” may e.g., an individual computer or a network of individual computers (e.g., laptops, desktops, workstations, etc.) with appropriate operating systems and application programs, or it may be any combination or portion of such computing mechanisms.

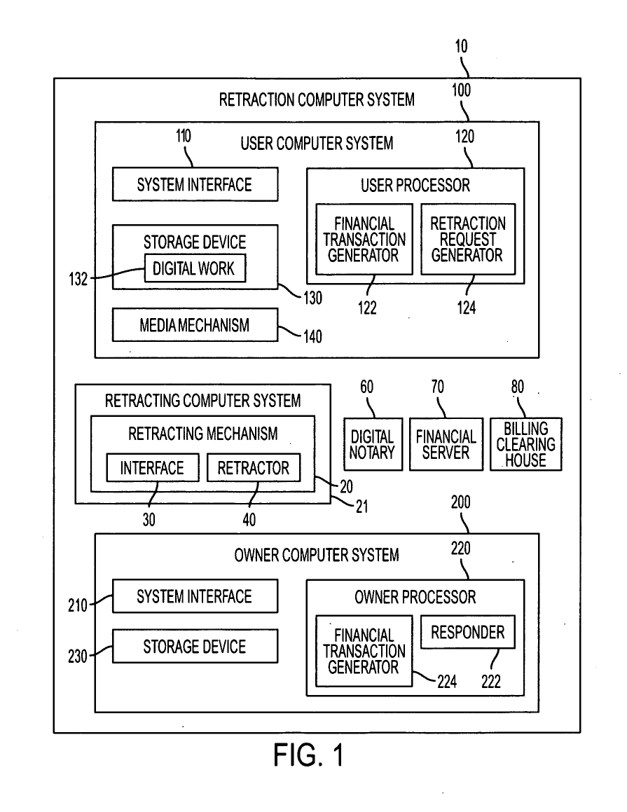

FIG. 1 is a block diagram of a retraction computer system 10. The illustrated retraction computer system 10 includes a retracting computer system 21, a user computer system 100, and an owner computer system 200. The illustrated system 10 may further include a digital notary 60, a financial server 70, and a billing clearinghouse 80.

The user computer system 100 is coupled to the retracting computer system 21. The owner computer system 200 is also coupled to the retracting computer system 21. The retraction computer system 10 may contain a plurality of user computer systems 100 and a plurality of owner computer systems 200, and the connections to any of these systems need not be permanent. However, for ease of description, it will be assumed in the following that the retraction computer system 10 has one user computer system 100 and one owner computer system 200.

The retracting computer system 21 includes a retracting mechanism 20 that further comprises an interface 30 and a retractor 40. The interface 30 receives and communicates with other entities including user and owner computer systems 100 and 200, respectively. The retractor 40 oversees the retraction communications between the user computer system 100 and the owner computer system 200, changes the attached usage rights to the digital work 132, and removes the digital work 132 from the user computer system's 100 storage device 130 upon agreement of the user computer system 100 and owner computer system 200.

The retractor 40 may return the retracted digital work to the owner computer system 200 or send the owner computer system 200 a confirmation of the completed retraction of the digital work 132. The retractor 40 may not physically retract the digital work 132 from the user computer system 100, but rather it may render the work unusable. One way of rendering the work unusable is removing or reducing the usage rights attached to the digital work 132 in the user computer system's 100 possession. A copy of the signed request (indicating both parties' agreement to the retraction) may also be attached to the unusable digital work remaining in the user computer system's 100 possession in a similar manner as the usage rights, e.g., glyph format, usage right grammar.

In the illustrated embodiment, the user computer system 100 includes a system interface 110, a user processor 120, a storage device 130, and a media mechanism 140. The system interface 110 facilitates communication between the user computer system 100 and other entities, for example, the retracting computer system 21, digital notary 60, financial server 70 and the user. The user processor 120 further comprises a financial transaction generator 122 and a request generator 124. A financial transaction generator 122 sends a credit request to a financial server 70 to obtain a credit for the return of the digital work 132 with unused rights. The request generator 124 initiates a request to the owner computer system 200 via retracting mechanism 20, as well as the retraction of the (e.g., pre-paid) rights to the digital work 132 and the actual digital work 132 upon the agreement of the owner. The request generator 124 allows the user to digitally sign the request in the illustrated embodiment. The storage device 130 contains at least one digital work. The media mechanism 140 allows the user to access the digital work using the usage rights he or she has purchased.

For purposes of security, the user computer system and owner computer systems digitally sign the request in the illustrated embodiment. A digital signature is data which accompanies a digitally encoded message and can be used to ascertain the source of the message and the fact that the message has not been modified since leaving that source in accordance with the digital signature algorithm issued in August 1991 as the digital signature standard by the U.S. National Institute of Standards and Technology, or other digital signature standards or versions of digital signature algorithms. Alternatively, other signature schemes, such as the RSA digital signature scheme, may also be used. However, the request may be signed or marked with a unique identifier associated with the user for validating the request in other embodiments.

To ensure secure signing by the user (and the owner in subsequent communications), the illustrated embodiment implements a suitable public key infrastructure (PKI) for purposes of authentication and authorization for such a request and act. However, other appropriate secure identification methods may also be implemented for purposes of authorization and authentication, e.g., private keys and cryptographic protocols. These security and verification methods can be multileveled and involve additional parties.

In the illustrated embodiment, the owner computer system 200 comprises a system interface 210, an owner processor 220, and a storage device 230. The system interface 210 facilitates the communication between the owner system and other entities including the retracting computer system 21, digital notary 60, financial server 70, and owner. The owner processor 220 further comprises a responder 222 and financial transaction generator 224. The responder 222 communicates the owner's response to the request for the retraction via the system interface 210 and retracting mechanism 20. In this embodiment, the responder 222 allows the user to digitally sign the request. The financial transaction generator 224 initiates the credit transaction associated with the return of unused prepaid usage rights to the user.

If the owner assents to the retraction request, the response is sent with the owner's digital signature attached to the response in the illustrated embodiment. The owner computer system 200 may maintain a copy of the signed request in its storage device 230. The digital signature of the owner computer system 200 is authenticated and authorized using a secure identification means, in this case PKI.

Each of the user computer system 100 and owner computer system 200 is coupled to a digital notary 60 and a financial server 70, which in turn is coupled to a billing clearinghouse 80. In the illustrated embodiment, the digital notary 60 confirms the signatures of each of the systems 100 and 200 on the signed request via an appropriate security or encryption mechanism. The signed request is a request signed by both the user computer system 100 and the owner computer system 200 that indicates their agreement regarding the retraction in this embodiment. This may be achieved using public and private keys or any appropriate security/authentication device, system, or capability. The digital notary 60 sends a copy of the notarized signed request to each of the user computer system 100 and owner computer system 200, respectively. Each of these systems 100 and 200 stores a copy of the notarized signed request in their respective storage devices 130 and 230.

To ensure accuracy and agreement regarding the transaction, the financial server 70 compares the recorded transaction initiated by the user computer system 100 with the one initiated by the owner computer system 200 to ensure accuracy of the credit transaction in the illustrated embodiment. The financial server 70 addresses any conflict between these two transactions with the user and owner computer systems 100 and 200, respectively. If the financial transactions of each of the systems correspond to each other, the financial server 70 forwards the transaction to the billing clearinghouse 80 for payment by the owner. However, the transaction generated by financial transaction generator 122 of the user computer system 100 is optional and need not be conducted for the financial server 70 to process the transaction to the billing clearinghouse 80.

The billing clearinghouse 80 in this illustrated embodiment is a financial institution. These transactions can be electronically accomplished using electronic fund transfers or other secure electronic financial transaction mechanisms. However, the billing clearinghouse may be a debit account or any financially capable system able to transact the appropriate payment, if any.

As stated earlier, the retracting mechanism 20 is part of the retracting computer system 21, which may be a document rights server or part of a document rights server connected to the user and owner computer systems 100 and 200, respectively, via a network connection (e.g., the Internet). The retracting mechanism 20 in the embodiment is a program located on the retracting computer system 21, accessible by applications in the user computer system 100 and owner computer system 200 via an API. The API facilitates the input of necessary data by both the user computer system 100 and owner computer system 200.

The retractor 40 may retract the rights using defined rights language or grammar; such as those described in U.S. Pat. No. 5,629,890 to Stefik et al., or other programmable instructions or modules. Retractor 40, although implemented as a coded software program on a computer in certain embodiments of the invention, may be implemented as a general or special purpose computing mechanism or any other computing mechanism or portion thereof capable of performing the described functions. For example, retractor 40 could be a general purpose microprocessor provided with an appropriate set of program instructions or an ASIC. In addition, retractor 40 may comprise a set of program instructions or program modules that cause a computer, ASIC, or other computing element to perform the described functions.

In embodiments, system interface 110 and 210 may comprise a computer or data display screen with an input means, such as a keyboard and/or mouse. In one embodiment, the storage device 130 and 230 are a hard drive or portion thereof. However, other types of storage and memory devices, such as a separate server platform, may also be used.

User and owner inputs may be received via a web-based screen or other appropriate information gathering programs, mechanisms, or devices. In the illustrated embodiment, the system interface 110 receives the necessary information from the user which is communicated to the request generator 124 of the user processor 120 resulting in an API call; such as retract (prepaid-rights-id, date-in-effect, user-id, signed message). The request may also be initiated via other appropriate mechanism or command capable of obtaining the necessary inputs to the retracting mechanism 20 and invoking its functions.

In the illustrated embodiment, the user processor 120, media mechanism 140, and owner processor 220 are each implemented as a coded software program on a general purpose computer. Alternatively, they may be implemented as a general or specific special purpose computing mechanism or any other computing mechanism or portion thereof capable of performing the described functions. For example, any of these elements could be a general purpose microprocessor provided with an appropriate set of program instructions or program modules that cause a computer, ASIC, or other computing element to perform the described function.

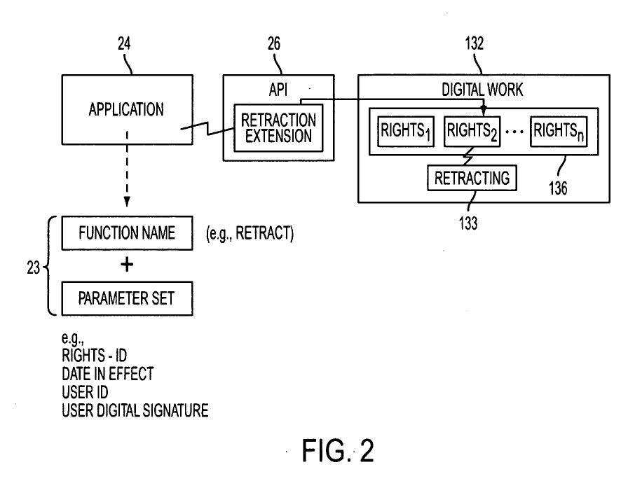

FIG. 2 schematically depicts the interaction among the data structures involved in the retraction of rights from digital work 132 using the API. Application 24 includes information 23 that may include a function name and parameter set. Application 24 gathers the information 23 from the user in a form that invokes the retraction extension of API 26. API 26 accesses usage rights 136 to the digital work 132, and retracts the specific right(s) of usage rights 136 as illustrated at 133.

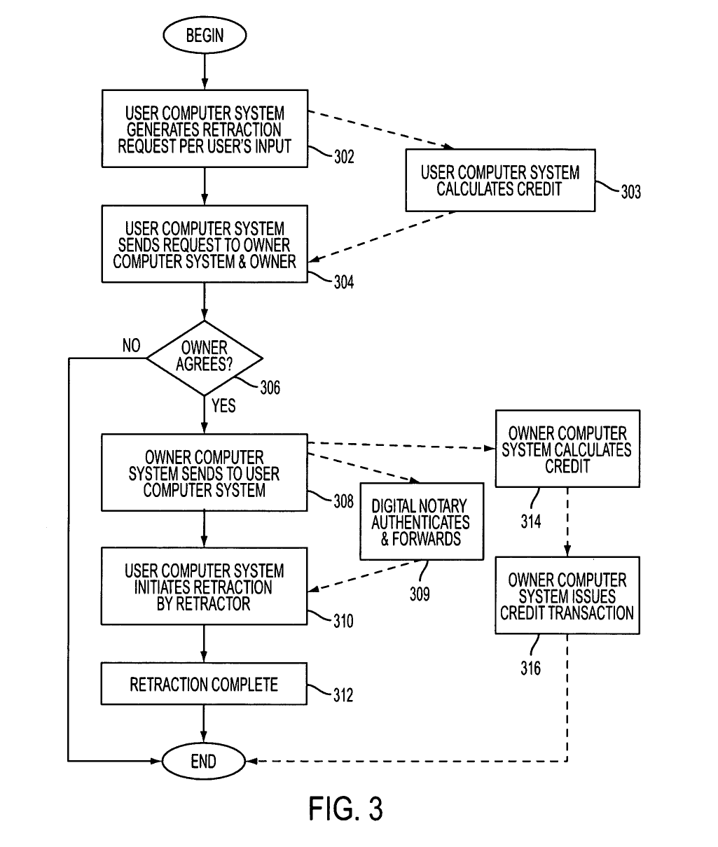

FIG. 3 is a flow chart of one embodiment of the retraction process 300 between a user computer system 100 and an owner computer system 200 (please refer to previously described FIG. 1 for references to system elements) by which a user requests to reduce previously granted usage rights to a digital work 132. Before the retraction process begins, the user computer system 100 contains digital work 132 that the user previously obtained usage rights to a digital work from an owner. The retraction process begins at act 302 where the user computer system 100 receives user inputs via the system interface 110 that initiate the generation of an API call. As a result, the request generator 124 generates a request for the retraction of the rights to the digital work 132. The API may also assist in the removal of the actual digital work 132 from the storage device 130 of the user computer system 100.

An optional act 303 is shown, in which concurrently with act 302, the user computer system 100 calculates the monetary credit it expects to receive if the retraction request is granted. The financial transaction generator 122 forwards this calculated amount for informational purposes to the financial server 70. Use of this calculated amount is discussed further later.

The retraction process proceeds from act 302 to act 304 where the user computer system 100 sends the request for retraction to the owner computer system 200 via the retracting computer system 21. Upon receipt of the request, the owner computer system 200 communicates the request to the owner. The process continues to act 306 where the owner considers the request. As part of his or her decision, the owner via the owner computer system 200 may want to assess the pre-paid rights at issue, e.g., does the user actually possess remaining pre-paid rights to the digital work?. If the owner does not agree to the request, the owner computer system 200 sends a negative response to the user computer system 100 via the retracting computer system 21, as shown in act 306:No. A negative response from the owner computer system 200 ends the retraction process.

In the illustrated embodiment, if the owner assents to the request, the owner computer system 200 responds by digitally signing the request using a secure means—PKI in this embodiment as mentioned above—in act 306: Yes. In the next step act 308 of the retraction process 300, the owner computer system 200 returns the signed request via the retracting computer system 21 to the user computer system 100. Upon receipt of the signed request, an optional act 309 may occur where the user computer system 100 forwards the signed request to a digital notary 60 for notarizing. The digital notary 60 will forward a copy of the notarized signed request to both the user computer system 100 and owner computer system 200 for saving in their respective storage devices 130 and 230, respectively. In another embodiment, the owner computer system 200 or an intermediate third party may initiate the interaction and coordinate the interaction with the digital notary 60.

Once the request has been signed in act 308 (and after notarization in act 309, if applicable), the retraction process continues to act 310 where the user computer system 100 initiates the retraction of the remaining pre-paid rights and the physical removal of the digital work 132 through the request generator 124. In this step, the request generator 124 communicates with the retractor 40 via the system interface 110 and the interface 30 to retract the usage rights and physically remove the digital work 132 from its storage device 130. Upon completion of the successful retraction of the usage rights and the digital work 132, the retraction process is complete.

A rights defining tag accompanying the retracted work would be updated to indicate the retraction. If a work is provided with an access or use enable or key (unlock) technology, that technology could be used to disable the work, to remove access to the work, or to automatically communicate authorized use (or unauthorized use) to the owner.

A user may request a rights retraction, for example, because he or she no longer needs a given work, he or she finds a better alternative source for the work, or he or she wants a different version (e.g., a newly available updated version).

Simultaneous or in conjunction with act 310, the retraction process may proceed with optional acts 314 and 316. Act 316 follows act 314. In act 314, the owner computer system 200 calculates the remaining monetary credit, if any, for the unused pre-paid rights that are subject of the signed request using the financial transaction generator 224 of the owner processor 220. If any credit remains, the retraction process proceeds to act 316. In act 316, the financial transaction generator 224 initiates a credit transaction to the financial server 70 via the system interface 210. As discussed earlier, the user computer system 100 may have calculated the expected monetary credit earlier in the process. If so, the financial server 70 compares the credit calculations of each of the user computer system 100 and owner computer system 200. If there is a discrepancy in the calculations, the financial server 70 reconciles this with both systems 100 and 200 prior to forwarding the credit transaction to a billing clearinghouse 80 for payment.

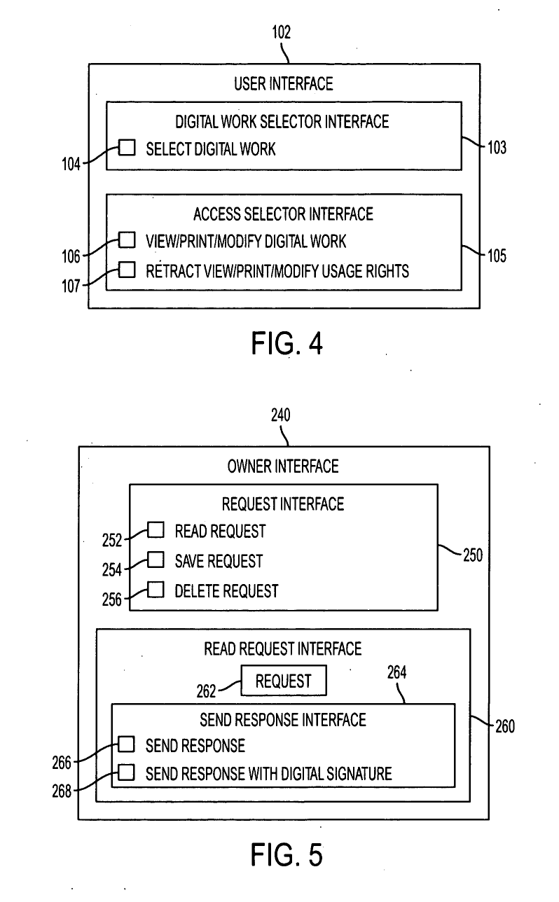

FIG. 4 is a schematic illustration of a user interface as part of system interface 110 of user computer system 100. User interface 102 includes a digital work selector interface 103 and access selector interface 105.

In embodiments, a graphical tool may, for example, include an icon or button that can be activated by clicking a mouse with a cursor situated over the icon or button. A graphical tool may include a form or textual input represented on a computer screen. A graphical tool may include a menu, displayed symbols, or text that could be chosen by pointing to and clicking over a given symbol or text. The graphical tool can also include a drop down menu or any other type of graphical tool. Alternatively, other tools may be provided to allow a user to control and operate the user interface 102.

Digital work selector interface 103 may include icons or otherwise manipulable graphical tools to allow the user to select a digital work usage from which he or she seeks to retract usage rights at 104. A browse icon may be included to allow the user to use a browse function to select the digital work to be accessed.

Access selector interface 105 may include icons or otherwise manipulable graphical tools to allow the user to use the granted usage rights, e.g., view, print, modify the digital work at 106 and request to retract the granted usage rights at 107. If the user chooses to request the retraction of usage rights at 107, the user computer system 100 sends a request to the owner computer system 200.

FIG. 5 is a schematic illustration of an owner interface 240 of the system interface 210 of the owner computer system 200. The owner interface 240 includes a request interface 250 and a read request interface 260. The request interface 250 may include icons or otherwise manipulable graphical tools to allow the owner to read the request at 252, save the request at 254, or delete the request at 256. The request interface 250 may work in conjunction with any email application.

If the owner chooses to read the request, the read request interface 260 includes the request and a sent response interface 264. If the owner chooses to send a response, the send response interface 264 instructs the owner computer system 200 to send a response at 266 or 268 depending on whether the owner wants his or her response to be digitally signed. The request interface 250 and the read request interface 260 may include icons or otherwise manipulable graphical tools to allow the owner to read a request and send a response, if he or she so desires.

Each element described hereinabove may be implemented with a hardware processor together with computer memory executing software or with specialized hardware for carrying out the same functionality. Any data handled in such processing or created as a result of such processing can be stored in any type of memory available to the artisan and appropriate for such data. For purposes of disclosure herein, computer readable media may comprise any form of data storage mechanism, including such different memory technologies, as well as hardware or circuit representations of such structures and of such data.

Furthermore, transactions and retractions described herein may refer to all of a digital work or any part thereof, as well as a digital work that is a compilation of other digital works.

The claims as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
a user interface;
a media mechanism to provide user access to a digital work via the user interface in accordance with usage rights associated with the digital work; and
a retraction request mechanism to request a retraction of the usage rights to a digital work.

2. The apparatus according to claim 1, further comprising a retracting mechanism to reduce usage rights to the digital work.

3. The apparatus according to claim 2, comprising a digital work and associated usage rights wherein the associated usage rights are attached to or incorporated into the digital work.

4. The apparatus according to claim 2, wherein the retracting mechanism includes a request communicator to communicate the request from a user computer system including the media mechanism to a separate owner computer system of an owner of the usage rights.

5. The apparatus according to claim 4, wherein the owner computer system includes a responder for an owner to communicate an approval of the request to the user computer system, wherein the owner is a person or entity that currently possesses the authority to approve the request.

6. The apparatus according to claim 5 wherein the user computer system includes a computer screen and a computer screen displayed retraction request interface via which a human user is to initiate a retraction request.

7. The apparatus according to claim 6, wherein the owner computer system includes a computer screen and a computer screen displayed responder interface via which a human owner is to control a response to a retraction request.

8. The apparatus according to claim 5, wherein the owner computer system further includes a financial transaction generator to calculate a monetary credit for the user when the request is approved.

9. The apparatus according to claim 8, further comprising a billing clearinghouse, the user computer system including a forwarding mechanism to forward the monetary credit to the billing clearinghouse to effect payment to the user.

10. The apparatus according to claim 6, wherein the user computer system includes a user unique identification mechanism to attach a unique identifier to validate the retraction request.

11. The apparatus according to claim 10, wherein the owner computer system includes an owner unique identification mechanism to attach a unique identifier to a request response to validate an approval.

12. The apparatus according to claim 11, further comprising a notary system to authenticate the attached user unique identifier and the attached owner unique identifier.

13. The apparatus according to claim 12, wherein the user unique identifier and the owner unique identifier include digital signatures.

14. A method comprising:
a user accessing a digital work via a user interface in accordance with usage rights associated with the digital work; and
requesting a retraction of the usage rights.

15. The method according to claim 14, further comprising:
reducing usage rights of the digital work.

16. The method according to claim 14, further comprising:
communicating a request for retraction of the usage rights from a user computer system to a separate owner computer system of an owner of the usage rights.

17. The method according to claim 16, further comprising:
the owner computer system responding to a request for retraction of the usage rights.

18. Machine readable media encoded with data, the data being interoperable with a machine to cause:
a user accessing a digital work via a user interface in accordance with usage rights associated with the digital work; and
requesting a retraction of the usage rights.

19. The machine readable media according to claim 18, the data being interoperable with a machine to cause:
reducing the usage rights.

20. The machine readable media according to claim 18, the data being interoperable with a machine to cause:
a user computer system communicating a request for retraction of the usage rights to a separate owner computer system of an owner of the usage rights.
